(19) United States
(12) Patent Application Publication
(10) Pub. No.: US 2008/0001537 A1
(43) Pub. Date: Jan. 3, 2008

(54) System for displaying images

(75) Inventors: Hsueh-Wen Chen, Cingshuei Township (TW); Pei-Hsun Yeh, Taichung City (TW)

Correspondence Address: LIU & LIU, 444 S. FLOWER STREET, SUITE 1750, LOS ANGELES, CA, 90071, US

(73) Assignee: TPO Displays Corp.

(21) Appl. No.: 11/478,177

(22) Filed: Jun. 28, 2006

(51) Int. Cl. H01J 1/62; H01J 63/04

(52) U.S. Cl. 313/506

(57) ABSTRACT

Systems for displaying images are provided. A representative system incorporates a light-emitting device is disclosed. The light emitting device comprises a plurality of rows of pixels are disposed on a substrate, wherein each of the pixels comprises an anode and an organic light emitting layer disposed overlying the anode. A primary cathode layer is disposed on the rows of the pixels, electrically connecting thereof. A plurality of patterned auxiliary cathodes are disposed on the primary cathode layer, and between each two rows of pixels.

### BACKGROUND OF THE INVENTION

1. Field of the Invention

The invention relates to a display device, and more particularly to an organic light emitting device.

2. Description of the Related Art

Organic light emitting devices are characterized by their thin profile and light weight, and process the advantages of self luminescence, high luminescent efficiency and low driving voltage. In accordance with organic luminescent materials, the organic light emitting device can be a molecule-based device or a polymer-based device. The molecule-based device, called an organic light emitting device (OLED), uses dyes or pigments to form an organic luminescent thin film. The polymer-based device, called a polymer light emitting device (PLED), uses conjugated polymers to form an organic luminescent thin film.

FIG. 1 is a sectional diagram of a conventional organic light emitting device. An OLED comprises a glass substrate 100 having an anode layer 102, a hole-injecting layer 104, a hole-transporting layer 106, an organic luminescent material layer 108, an electron-transporting layer 110, an electron-injecting layer 112 and a primary cathode layer 114. The anode layer 102 is indium tin oxide (In₂O₃:Sn, ITO) which has advantages of facile etchability, low film-formation temperature and low resistance. When a bias voltage is applied to the OLED, an electron and a hole passing through the electron-transporting layer 110 and the hole-transporting layer 106 respectively enter the organic luminescent material layer 108 to combine as an exciton and then release energy to return to ground state. Particularly, depending on the nature of the organic luminescent material, the released energy presents different colors of light including red light (R), green light (G) and blue light (B). The light is emitted from one end adjacent to the anode layer 102.

Typically, in order to achieve a low resistance of the cathode layer 114, the cathode layer 114, such as ITO or thin film metal formed by sputtering, for top emission type is required to be thicker. The underlying organic layers 112, 110, 108, 106 and 104, however, are likely damaged by sputtering ions when forming the cathode layer 114 with sufficient thickness. In order to reduce damage of the organic layer 112, 110, 108, 106 and 104, the cathode layer 114 can be formed by low depositing rate process. The low depositing rate process of forming cathode layer 114, however, reduces throughput.

### BRIEF SUMMARY OF THE INVENTION

A detailed description is given in the following embodiments with reference to the accompanying drawings. These and other problems are generally solved or circumvented, and technical advantages are generally achieved, by illustrative embodiments of the present invention, which provide an organic light emitting device.

Systems for displaying images are provided. In this regard, an embodiment of the invention provides a light emitting device. The light emitting device comprises a plurality of rows of pixels are disposed on a substrate, wherein each of the pixels comprises an anode and an organic light emitting layer disposed overlying the anode. A primary cathode layer is disposed on the rows of the pixels, electrically connecting thereof. A plurality of patterned auxiliary cathodes are disposed on the primary cathode layer, and between each two rows of pixels.

### BRIEF DESCRIPTION OF THE DRAWINGS

The present invention can be more fully understood by reading the subsequent detailed description and examples with references made to the accompanying drawings, wherein:

FIG. 1 is a sectional diagram of a conventional organic light emitting device.

FIG. 2 shows a top view of a system for, displaying images of an embodiment of the invention.

FIG. 3A shows a cross-section along line I-I′ of FIG.3.

FIG. 3B shows a cross-section along line II-II′ of FIG.3.

FIG. 3C shows a cross-section of final product of a system for displaying images of an embodiment of the invention.

FIG. 4 shows a top view of a system for displaying images of another embodiment of the invention.

FIG. 5 shows a top view of a system for displaying images of further another embodiment of the invention

FIG. 6 shows a cross-section along line I-I′ of FIG. 6.

FIG. 7 schematically shows another embodiment of a system for displaying images.

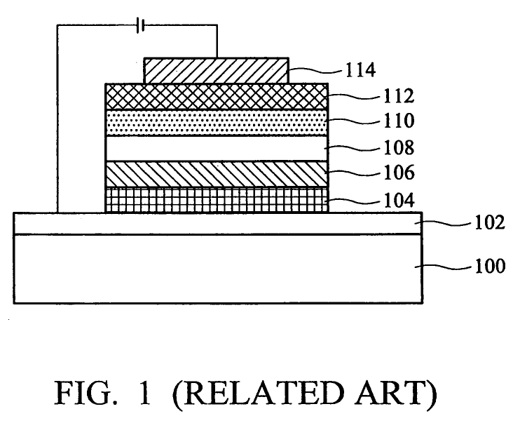

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims. Embodiments of the invention, which provides an organic light emitting device, will be described in greater detail by referring to the drawings that accompany the invention. It is noted that in the accompanying drawings, like and/or corresponding elements are referred to by like reference numerals.

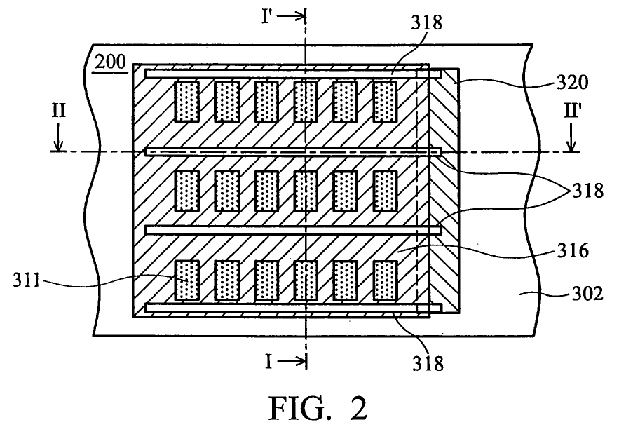

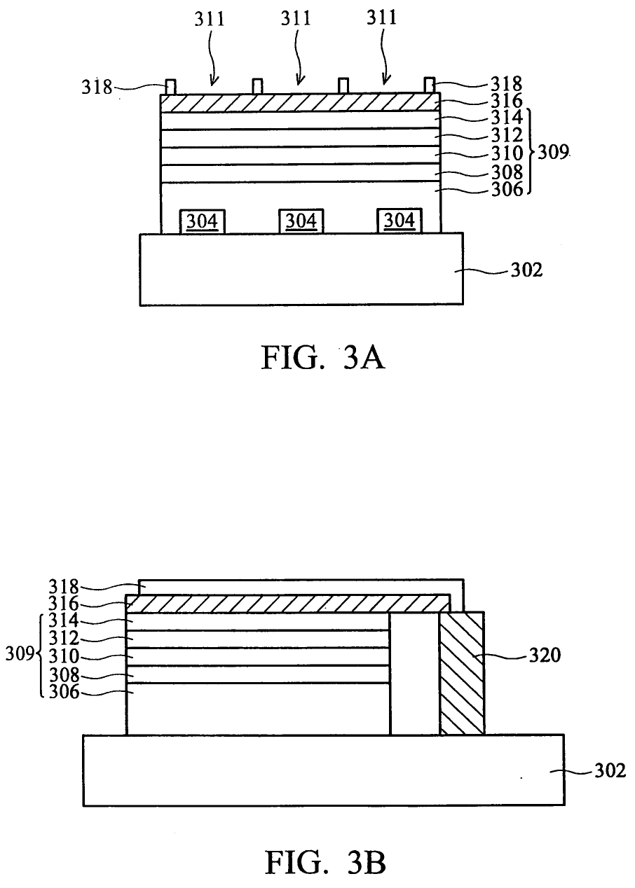

FIG. 2 shows top view of a system for displaying images, such as an organic light emitting device 200, of an embodiment of the invention. FIG. 3A shows a cross-section along line I-I′ of FIG. 2. FIG. 3B is a cross-section along line II-II′ of FIG. 2. Referring to FIG. 2, FIG. 3A and FIG. 3B, a substrate 302, such as glass, low alkali glass or non-alkali glass is provided. Next, anodes 304, such as ITO or IZO, are formed on the substrate 302. In an embodiment of the invention, the anodes 304 are arranged in a matrix.

Next, a hole-injecting layer 306, such as CuPc, TiOPc, m-MTDATA and/or 2-TNATA, is formed on the substrate 302 and the anodes 304. A hole-transporting layer 308, such as TPD, NPB (Kodak), PVK, Spiro-TPD (Convion) and/or Spiro-NPB (Convion) is formed on the hole-injecting layer 306. An organic luminescent material layer 310, such as Alq3, Almq3, Blue (Ricoh) and/or TBADN (Kodak) is formed on the hole-transporting layer 308. An electron-transporting layer 312, such as Alq3, Almq3, DVPBi (Idemitsu), TAZ (Sumitomo) and/or PBD (Idemitsu) is formed on the organic luminescent material layer 310. An electron-injecting layer 314, such as LiF, MgP, MgF2 and/or Al2O3 is formed on the electron-transporting layer 312.

A primary cathode layer 316, such as Ag, Al, Li, Ca, In, ITO and/or IZO is formed on the electron-injecting layer 314, for example by evaporation or sputtering. The combination of the hole-injecting layer 306, hole-transporting layer 308, organic luminescent material layer 310, electron-transporting layer 312 and electron-injecting layer 314 can be referred to as an organic light emitting layer 309 (OLED layer), in which can be achieved by evaporation, spin coating or other method. The primary cathode layer 316 can be a metal layer formed by evaporation. The primary cathode layer 316 can also be a transparent conductive layer, such as ITO or IZO formed by sputtering. The combination of the anodes 304, the hole-injecting layer 306, the hole-transporting layer 308, the organic luminescent material layer 310, the electron-transporting layer 312 and the electron-injecting layer 314 and the primary cathode layer 316 can be referred to as pixels 311, as shown in FIG. 2.

In order to reduce damage of the OLED layer 309 from ion sputtering, thickness of the primary cathode layer 316 can not be too thick. In a embodiment of the invention, the primary cathode layer 316 is about 20 Å˜500 Åthick. Resistance of the primary cathode layer 316, however, increases, when reducing thickness thereof. In order to eliminate the issues, in an embodiment of the invention, a plurality of patterned auxiliary cathodes 318 are formed on the primary cathode layer 316. The patterned auxiliary cathodes 318 are strips interposed between each two rows of pixels 311 and extend in a row direction for a distance of at least the length of two pixels 311. Note that the patterned auxiliary cathodes 318 are connected to a conductive pad 320 thereunder for supplying current (electrons and/or holes) to the pixels 311 for illumination. The patterned auxiliary cathodes 318 can be conductive materials, such as Ag, Al, Li, Ca, In, ITO and/or IZO. In a embodiment of the invention, the patterned auxiliary cathodes 318 are formed of Al, Ag or combination thereof, and about 1000 Å˜7000 Å. In another embodiment of the invention, the patterned auxiliary cathodes 318 can be a conductive line. In addition, the patterned auxiliary cathodes 318 is thicker than the primary cathode layer 316, thus, the patterned auxiliary cathodes 318 has lower resistance than the primary cathode layer 316.

Accordingly, electrons and/or holes can be transported from the conductive pad 320 to the patterned auxiliary cathodes 318 with lower resistance, and then further to the pixels 311. Due to the patterned auxiliary cathodes 318 with lower resistance, the primary cathode layer 316 can be thinner to reduce affection of the underlying OLED layer 309, and electrons and/or holes can be transported to pixels with less resistance.

Referring to FIG. 3C, a passivation layer 330, such as silicon nitride, is formed on the patterned auxiliary cathodes 318 and the primary cathode layer 316. A gap filling layer 332 can be polymer material, such as Polyimide, Acrylic, Epoxy . . . etc., is formed on the passivation layer 330. A top substrate 334, such as a color filter or glass substrate, is provided overlying the gap filling layer 332. Next, the OLED device is sealed by sealing layers 336.

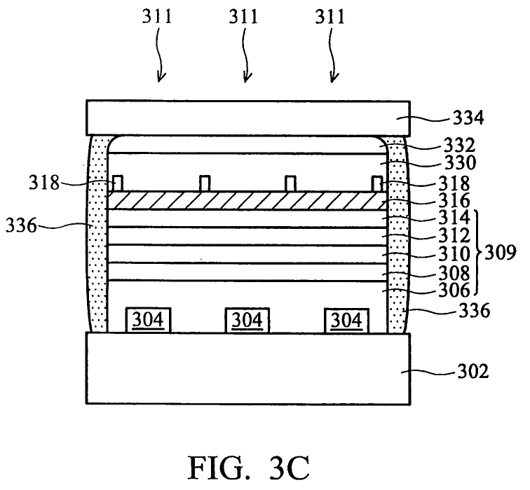

FIG. 4 shows a top view of system for displaying images, such as an organic light emitting device 502, of another embodiment of the invention. Referring to FIG. 4, most elements are the same as the embodiments described in the embodiment in FIG. 2, only the patterned auxiliary cathodes 358 differs. In this embodiment, the patterned auxiliary cathodes 358 comprise a plurality of separated smaller strips in a row, and at least one of the smaller strips is electrically connected to the conductive pads 320. The smaller strips are separated with each other, and are thicker than the cathode layer 316. Thus, the patterned auxiliary cathodes 358 comprises a plurality of smaller strips has lower resistance. Due to the low resistance of the patterned auxiliary cathodes 358, current can be more easily transported to the pixels 311 away form the conductive pads 320.

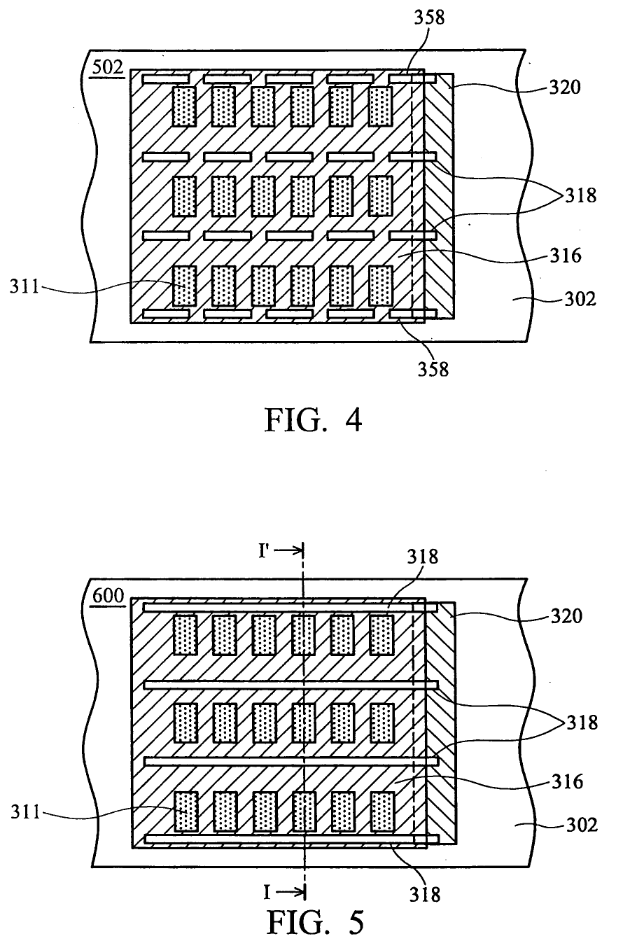

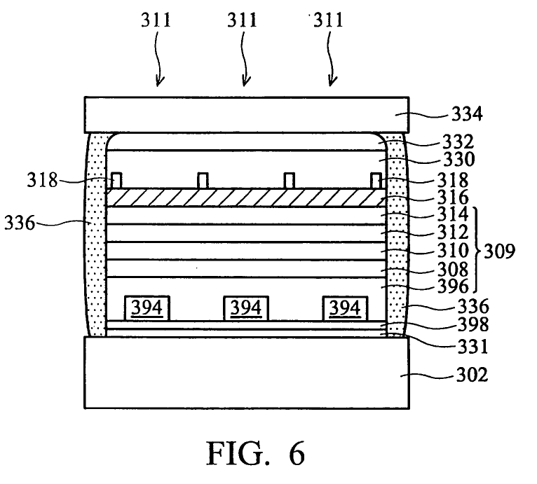

The invention is not limited to the described double-emitting OLED devices. In one embodiment of the invention, the feature described can be used in top-emitting OLED devices. FIG. 5 shows a top view of a system for displaying images, such as an organic light emitting device 600, of further another embodiment of the invention. FIG. 6 is a cross section along line I-I′ of FIG. 5. Note that the same or the like elements use the same symbols as the described embodiments, and the same feature is not described in detail. As shown in FIG. 5 and FIG. 6, the differences between of this embodiment and the described embodiment in FIG. 2 and FIG. 3C is that the device herein is a top-emitting OLED devices comprising patterned auxiliary cathodes 318 on the cathode layer 316. In the top-emitting OLED devices, the anode 394 is formed of reflective materials, such as Cr, and the hole-injecting layer 396 is metal oxide, such as Cr2O3. In addition, the top-emitting OLED devices further comprises an insulating layer 398, such as silicon oxide, silicon nitride or silicon oxynitride, underlying the anode 394 and the hole-injecting layer 396. A reflective layer 331, such as Al, Ag and/or alloy thereof, is disposed between the insulating layer 398 and the substrate 302. The combination of the hole-injecting layer 396, hole-transporting layer 308, organic luminescent material layer 310, electron-transporting layer 312 and electron-injecting layer 314 can be referred to as an organic light emitting layer 309 (OLED layer).

According to the embodiments described, the primary cathode layer 316 can be formed with thinner thickness to reduce damage to the underlying OLED layer 309. Due to the low resistance of the patterned auxiliary cathodes 318 interposed between each two rows of pixels 311, current can be more easily transported to the pixels 311 away form the conductive pads 320. Therefore, non-uniformity from different electron transporting path between pixels 311 away and near the conductive pads could be eliminated. Therefore, non-uniformity issues of illumination between pixels 311 could be eliminated.

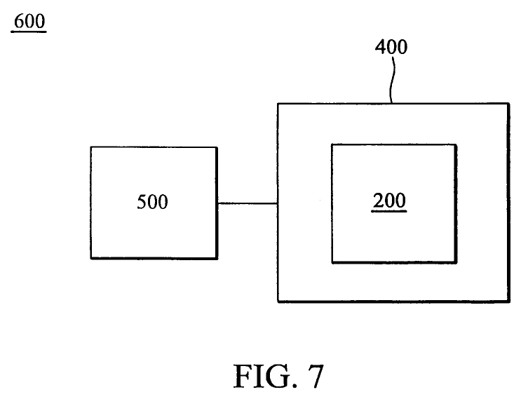

FIG. 7 schematically shows another embodiment of a system for displaying images which, in this case, is implemented as a display panel 400 or an electronic device 600. The described display device can be incorporated into a display panel. As shown in FIG. 7, the display panel 400 comprises a display device, such as the OLED device 200 shown in FIG. 2, the OLED device 502 in FIG. 4 or the OLED device 600 in FIG. 5. The display panel 400 can form a portion of a variety of electronic devices (in this case, electronic device 600). Generally, the electronic device 600 can comprise the display panel 400 and an input unit 500. Further, the input unit 500 is operatively coupled to the display panel 400 and provides input signals (e.g., an image signal) to the display panel 400 to generate images. The electronic device 600 can be a mobile phone, digital camera, PDA (personal data assistant), notebook computer, desktop computer, television, car display, or portable DVD player, for example.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for displaying images, comprising:
a light-emitting device, comprising:
a first substrate;
a plurality rows of pixels disposed overlying the substrate, wherein each of the pixels comprises an anode and an organic light emitting layer disposed overlying the anode;
a primary cathode layer disposed overlying the rows of the pixels, and electrically connecting thereof, and
a plurality of patterned auxiliary cathodes disposed overlying the primary cathode layer, and between each two rows of pixels.

2. The system as claimed in claim 1, wherein the patterned auxiliary cathodes are electrically connected to a conductive pad to supply current to the organic light emitting layer.

3. The system as claimed in claim 1, wherein the patterned auxiliary cathodes are strips, and each strip extends along each row.

4. The system as claimed in claim 3, wherein one of the strips is constituted by a plurality of separated smaller strips.

5. The system as claimed in claim 4, wherein the strips are electrically connected to a conductive pad to supply current to the organic light emitting layer.

6. The system as claimed in claim 1, wherein the patterned auxiliary cathodes are thicker than the primary cathode layer.

7. The system as claimed in claim 6, wherein the thickness of primary cathode layer is about 20 Å˜500 Å, and the thickness of patterned auxiliary cathodes are about 1000 Å˜7000 Å.

8. The system as claimed in claim 1, wherein the patterned auxiliary cathodes comprise Ag, Al, Li, Ca, In, ITO and IZO.

9. The system as claimed in claim 1, further comprising a reflective layer interposed between the pixels and the substrate.

10. The system as claimed in claim 1, further comprising:
a protective layer disposed overlying the patterned auxiliary cathodes and the primary cathode layer;
a gap filling layer disposed overlying the protective layer;
a second substrate disposed overlying the gap filling layer; and
a sealing layer sealing the light-emitting device.

11. The system as claimed in claim 1, further comprising a display panel, wherein the light-emitting device forms a portion of the display panel.

12. The system as claimed in claim 1, further comprising an electronic device, wherein the electronic device comprises:
the display panel; and
an input unit coupled to the display panel and operative to provide input to the display panel such that the display panel displays images.

13. A system for displaying images, comprising:
a light-emitting device, comprising:
a substrate;
a plurality of rows of pixels disposed overlying the substrate, wherein each of the pixels comprises an anode and an organic light emitting layer;
a primary cathode layer disposed overlying the rows of pixels, and electrically connecting thereof; and
a plurality of patterned auxiliary cathodes disposed overlying the primary cathode layer, and between each two rows of pixels,
wherein the patterned auxiliary cathodes are conductive lines, electrically connected to a conductive pad to supply current to the organic light emitting layer;
wherein resistance of patterned auxiliary cathodes is lower than the primary cathode layer.

14. The system as claimed in, claim 13, wherein the patterned auxiliary cathodes comprise Ag, Al, Li, Ca, In, ITO and IZO.

15. The system as claimed in claim 13, wherein the thickness of the primary cathode layer is about 100 Å˜500 Å.

16. The system as claimed in claim 13, wherein the thickness of the patterned auxiliary cathodes are about 2000 Å˜7000 Å.

17. The system as claimed in claim 13, further comprising a display panel, wherein the light-emitting device forms a portion of the display panel.

18. The system claimed in claim 17, further comprising an electronic device, wherein the electronic device comprises:
the display panel; and
an input unit coupled to the display panel and operative to provide input to the display panel such that the display panel displays images.
